(19) United States
(12) Patent Application Publication
(10) Pub. No.: US 2004/0023041 A1
(43) Pub. Date: Feb. 5, 2004

(54) Solvogels and a method of manufacture of the same

(76) Inventors: Eoin Seirose O'Keefe, Farnborough, Hampshire (GB); Martin Swan, Franborough, Hampshire (GB)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/399,453

(22) PCT Filed: Oct. 11, 2001
(86) PCT No.: PCT/GB01/04550

(30) Foreign Application Priority Data
Oct. 24, 2000 (GB) 0025940.8

(51) Int. Cl. B32B 9/04

(52) U.S. Cl. 428/446

(57) ABSTRACT

A solvogel and a method of manufacture of the same is described which comprises a liquid phase encapsulated within porous metal oxide network produced by hydrolysing a metal alkoxide compound in the presence of at least one solvent system and a catalyst which subsequently polycondensates to form the solvogel. The solvogel may be multilayered where each layer may have different properties. The reaction may be controlled to produce an optically transparent material. The solvent system may comprise a solvent and at least one of the following, a solid material in suspension: a dye; a miscible liquid. The solvogel may be housed in a hermetically sealed containment cell forming a panel. The cell may be partially or fully transparent to visible light and may be tinted. The cell may comprise curved surfaces.

The sol-gel method for the manufacture of glass-like materials is well known. The method involves hydrolysing a metal alkoxide, for example silicon, titanium or aluminum, in the presence of water and a catalyst dissolved in a solvent The hydroxide that results from the reaction is polycondensated forming a skeletal network of metal oxide, which contains liquid by-products of the reactions, called the alcogel. This alcogel is then dried, removing the liquid by-products, by one of a number of processes producing either a microporous glass material or a dense glass. The solvents used in the process are volatile so they are easily removed during the drying process.

The present invention relates to the formation and the use of the intermediate product or alcogel which is obtained byte use of non-volatile liquids in the reaction and their retention in the product. For this reason the term solvogel will be used in place of the conventional word alcogel. The advantage of the intermediate product is that a material retaining many of the properties of the liquid phase, which is encapsulated in the network, is produced without the ability to flow. There are a number of applications where this ability is advantageous and these will be discussed later.

It is an object of the present invention to provide a liquid phase encapsulated within a porous metal oxide network otherwise known as a solvogel.

According to a first aspect of the present invention there is provided a solvogel comprising a liquid phase encapsulated within a porous metal oxide network, said liquid phase deriving from at least one non-volatile (as herein defined) solvent system.

According to a second aspect is a method for the production of a solvogel comprising hydrolysing a metal alkoxide compound in the presence of at least one non-volatile (as herein defined) solvent system and a catalyst which subsequently polycondensates to form the solvogel. The solvogel comprises a porous metal oxide network with a solvent encapsulated therein. The catalyst may be acidic or basic. The product of the hydrolysis reaction will be called the solvogel solution.

Preferably, the pores are less than 100 nm in size. More preferably, the production of the solvogel is controlled to produce an average pore structure that it results in an optically transparent material, where the pore size is less than 1/10^{th} of the wavelength of light i.e. ˜50 nm. This produces a high optical clarity. One application where this is beneficial is in the production of lightweight optical materials such as lenses. The solvogel may be manufactured in a variety of shapes and sizes. Also, the low density of a solvogel (1.0+0.1 g cm⁻³) means that it could be used as a lightweight alternative to silica glasses or polymers. Another use for an optically transparent solvogel is as a light pipe having a high transmission in the spectral range of 290-900 nm.

In a preferred embodiment, the alcohol formed during hydrolysis and alcohol condensation and the water formed during polycondensation is removed. It is advantageous for both by-products to be removed without having to use high temperatures as elevated temperatures increase the reaction rate and can lead to premature gelation. The presence of these by-products can lead to the formation of voids during polycondensation and subsequently after gelation. If the solvogel is to be exposed to elevated temperatures during use, it is important to remove these by-products as they could vaporise, leading to void formation which-slay impair properties.

Preferred metal alkoxide compounds used are TMOS (tetramethylorthosilicate)-Si(OCH₃)₄ and TEOS (tetraethylorthosilicate)-Si(OCH₂CH₃)₄.

The at least one solvent system used should be chemically compatible to the metal alkoxide or subsequent metal hydroxide alcohol solution and be non-volatile. The temperature of volatilisation is important for determining thermal stability of the end product. A non-volatile solvent system is generally regarded as having a boiling point of 100° C. or greater. Throughout this specification it is this definition of non-volatile that will be used.

Preferably, the solvent system used is selected from the groups comprising alcohols and diols. More preferably the solvent used is 1,2 ethanediol (also known as ethylene glycol). The solvent system may contain at least one of the following, a solid material in suspension; a dye; a miscible liquid.

A suitable solid material is aluminium powder. If a solvent soluble dye is incorporated into the solvogel, the material could be used as a filter for, for example, visible light, UV, and near infrared. Due to the nature of a solvogel a high concentration of dye can be incorporated, this makes this material suitable for safety goggles for use with lasers or welding equipment. High atomic mass materials, for example, lead as lead perchlorate can be dissolved in the solvent phase in high concentrations producing a material that can absorb ionising radiation whilst retaining optical clarity (if desired). This type of product could be used to replace lead loaded glasses.

A miscible liquid is a liquid which has a solubility constant close to that of the solvent. It could be a fragrance and, when incorporated into the solvogel and gradually released by a diffusion control mechanism, act as a scent delivery system; alternatively a controlled drug release material could be formulated Fuel sources could also be incorporated into the solvogel and recovered at a later stage allowing for safer transportation of hazardous liquids. A miscible liquid phase may take the form of an electrolyte with applications in fuel cells.

This second aspect of the invention will now be further described by way of exemplification; the following example relates to a solvogel formed from the hydrolysis and polycondensation of TMOS with basic water in an alcoholic solvent. This solvogel encapsulates the alcoholic solvent within the pores of its network.

The reaction scheme is as follows:

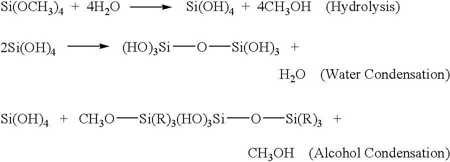

Where R is OCH₃ or OH depending on whether the reactant was partially or fully hydrolysed respectively.

Once hydrolysis has begun, polycondensation to form a solvogel will take place so the two reactions initially occur side by side. The rate of gelation is a function of the volume of solvent and the pH of the water used in the reaction. The more basic the solution, the greater the reaction rate. It will be apparent to a person skilled in the art, that there is an upper and lower limit to the volume of solvent that can be used in this reaction in order to form a solvogel.

The reaction rates for both the hydrolysis and condensation steps, as well as the microstructure of the gel are known to depend strongly on the catalyst. Also the catalyst concentration affects the size of the primarily metal oxide particles, the degree of crosslinking between them, and subsequently the strength of the microstructure and the clarity of the gel.

In a specific example, TMOS in 1,2 ethanediol is reacted at room temperature with 0.07 m ammonium hydroxide in the ratio 2:12:1 respectively by volume. In this example, the solution becomes miscible in approximately 10 minutes on stirring or agitating the solution indicating that the solubility of the liquids has become compatible and that a partial solvogel solution has been formed. The polycondensation reaction forming the solvogel takes approximately 3 hours, with sufficient gelation for structural stability being achieved in 8 hours.

The solvent by-product may be removed from the solution by using a rotary evaporator connected to a vacuum system or by placing the solution in a fume cupboard such that a large surface area of the solution is exposed to the fume cupboard draft. The water may be removed using molecular sieves. These methods will leave traces of both the solvent by-product and the water.

It will be readily apparent to the skilled addressee that substitution of the TMOS and 1,2 ethanediol with alternative suitable metal alkoxide compounds and solvents respectively and in the correct proportions, is possible. The properties of the resulting solvogel may be tailored to suit a particular purpose by such a substitution.

The solvogel structure allows the encapsulated solvent to diffuse. These are a number of applications for this property including the gradual release of perfumes or fragrances such as in an air freshener, the use of the material as a filter to separate nanosized particles or to retain particles for semiconductor processing fluids. The sizes of the pores allow it to be used as nano sized particle filter or separation media. The porous structure also exhibits vibrational properties, which could be coupled to make an acoustic damping material for application in architectural glazing for noisy environments.

One use for the filtering and diffusing properties of a solvogel is to encapsulate an article which may be fragile or cannot be exposed to air for example a biological specimen or historical artefact. The solvogel could be optically transparent thus allowing the article to be viewed whilst being protected from the atmosphere. The open cell nature also allows fluids to be brought into contact with such objects. Subsequently the solvogel is easily removed from the objects.

The solvogel could also be used to reduce the diffusivity of a liquid material, which may be beneficial in kinetically limited reactions.

According to a third aspect of the present invention there is provided a multilayered material, comprising at least one solvogel wherein each layer may have different properties.

According to a fourth aspect of the present invention there is provided containment means comprising a hermetically sealed containment cell housing at least one layer of solvogel. Solvogels are friable and easily damaged so such a containment system provides protection. Preferably, the containment means comprises a panel having a front and a back face and four side edges, the solvogel being encapsulated between the faces, the thickness of the solvogel being determined by the thickness of the side edges.

Preferably, the containment cell is manufactured from non-reactive polymers, composites or glass. More preferably the containment cell is formed from materials selected from the group comprising polymethylmethacrylate, polycarbonates or polyesters.

A solvogel has the visco behaviour of the encapsulated liquid and the elastic behaviour of the porous network which may work as an acoustic damping system. If the solvogel is optical clear this material could be used as architectural glazing for noisy environments.

This fourth aspect of the present invention will now be further described by way of example only and with reference to the drawings.

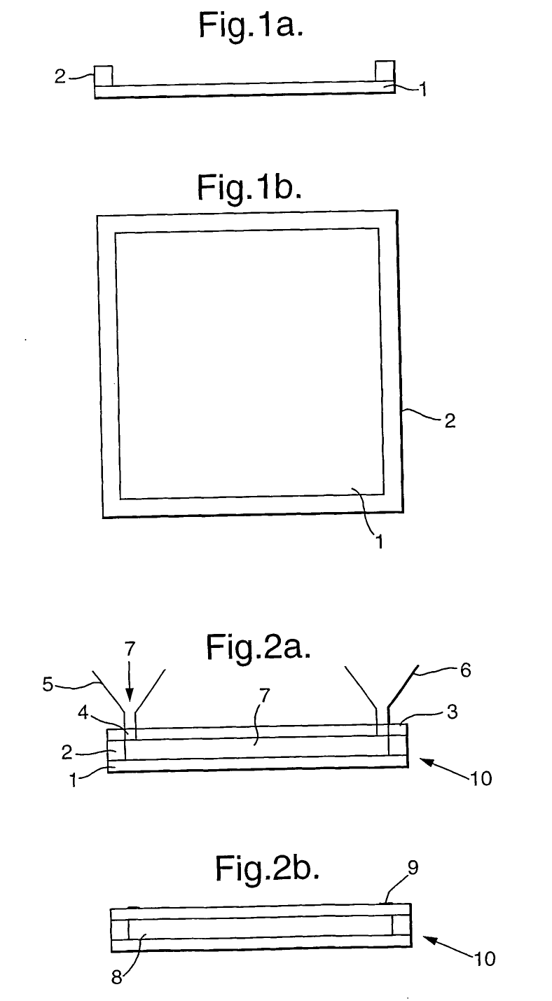

FIGS. 1a and b show a partially constructed cell in side and plan view respectively.

FIGS. 2a and b show the filling of a constructed cell with a solvogel solution and sealing of the cell respectively.

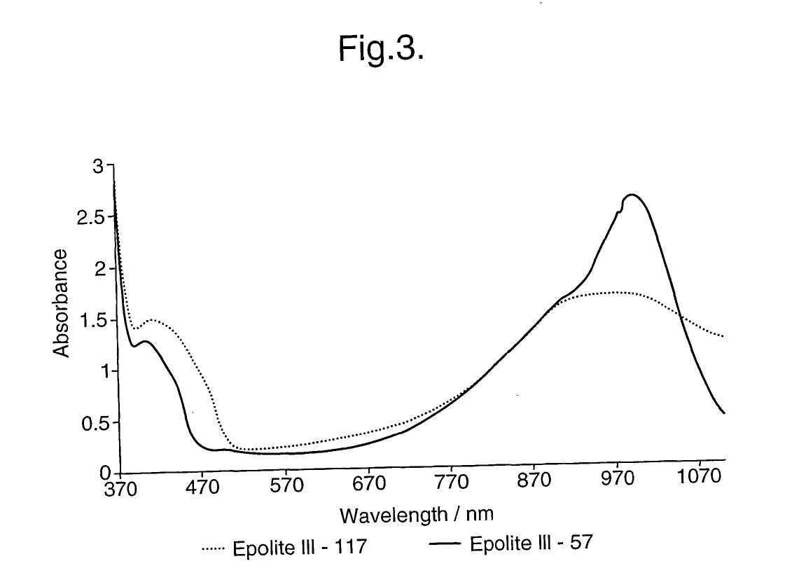

FIG. 3 shows a graph of an ultraviolet visible absorbance spectrum for the containment cells described in FIG. 2.

FIGS. 1a and b show a partially construction cell comprising a layer of Perspex 1 having a frame sealed around its outside edges 2. The frame is manufactured from a non-reactive polymer and is of a thickness appropriate for the thickness of the layer(s) of solvogel to be contained within the cell.

A containment cell is manufactured using a first sheet of Perspex 150 mm by 150 mm in size and 3 mm thick. The frame is manufactured from four Perspex spacers 150 mm long, 5 mm wide and 6 mm thick. Each spacer is sealed both to the Perspex sheet and to the edges of the other spacers abutting it.

FIG. 2a shows the further construction of cell 10 whereby a second layer of Perspex 3 is sealed to the frame 2. This second layer of Perspex has at least two openings on its surface 4 having funnels attached 5, 6. A layer of solvogel solution 7 is admitted into the cell 10 via funnel 5.

The construction of the cell is completed by sealing a second layer of Perspex of the same size and thickness to the first to the frame. This second layer of Perspex has two holes each 6 mm in diameter and positioned on a line diagonally bisecting the Perspex and at opposite sides of the Perspex, but not so close to the corners of the Perspex so as to be even partially covered by the spacers. A funnel is placed over each hole.

A first solvogel was made according to the following formulation. 120 cm³ of 1,3 butanediol was mixed with 20 cm³ of TMOS and 10 cm³ of 0.1M ammonium hydroxide. 14.5 mg of a laser absorbing dye, Epolite III-57 was dissolved into the solution. After 1 hour 300 μl of acetic acid was added to stabilise the dye. The solvogel solution 7 was then added to the cell 10 via the funnel 5 and allowed to gel. The gel time for this system is approximately 7 days. Acetone may also be added to the solvogel formulation to improve the initial solubility of the dye being used.

A second formulation for a solvogel, made in a different cell of the same construction as the first was made as follows. 120 cm³ of 1,3 butanediol was mixed with 20 cm³ of TMOS and 10 cm³ of 0.1M ammonium hydroxide. 23.5 mg of a laser absorbing dye, Epolite III-117 was dissolved 1 cm³ of acetone prior to addition to the solution. After 1 hour 300 μl of acetic acid was added to stabilise the dye. The solution was then added to the cell and allowed to gel. The gel time for this system is approximately 7 days.

The cell 10 may be inclined to assist in the removal of any air bubbles from the second funnel 6. After any air trapped in the cell 10 has been removed, more solution is poured into the first funnel until the cell 10 is completely filled and a small amount of solution remains in each funnel 5, 6.

FIG. 2b shows the cell 10, with the apertures 4 covered by Perspex caps 9. When the solvogel solution 8 has polycondensed into the solvogel, the funnels 6,7 are removed and the openings 5 in the Perspex 4 are capped with Perspex 9.

It will be apparent to a person skilled in the art that the cell need not be constructed out of one material. A different material may be used for the first and second layers or spacers.

If a multilayered material is required, subsequent layers of solvogel solutions having different properties may be added through the funnels. The depth of the spacers would have to be altered so that all the layers required could be accommodated within the cell.

FIG. 3 shows a graph of absorbance of a laser beam for the containment cells described in FIG. 2. The performance was measured 6 months after manufacture of the containment cells. Both the formulations referred to in FIG. 2 produced a transparent material suitable for use as a window or as the lens for safety equipment.

1. A solvogel comprising a liquid phase encapsulated within a porous metal oxide network, said liquid phase deriving from at least one non-volatile (as hereinbefore defined) solvent system.

2. A multilayered solvogel as claimed in claim 1 comprising at least two layers of solvogel wherein each layer may have different properties.

3. A method for the production of a solvogel comprising the reaction of hydrolysing a metal alkoxide compound in the presence of at least one non-volatile (as hereinbefore defined) solvent system and a catalyst which subsequently polycondensates to form the solvogel.

4. A method for the production of a solvogel as claimed in claim 3 wherein the reaction is controlled to produce pores of less than 100 nm.

5. A method for the production of a solvogel as claimed in 4 wherein the average pore size is less than 50 nm.

6. A method for the production of a solvogel as claimed in claims 3 to 5 wherein the water formed during the polycondensation is removed.

7. A method for the production of a solvogel as claimed in claims 3 to 6 wherein the alcohol by-product is removed.

8. A method for the production of a solvogel as claimed in claims 3 to 7 wherein the metal alkoxide used is selected from the group comprising Si(OCH3)4 and Si(OCH2CH3)4.

9. A method for the production of a solvogel as claimed in claims 3 to 8 wherein the at least one solvent system is selected from the group comprising alcohols and diols.

10. A method for the production of a solvogel as claimed in claim 9 wherein the at least one solvent system comprises a solvent and at least one of the following, a solid material in suspension; a dye.

11. A method for the production of a solvogel as claimed in claims 3 to 10 wherein the catalyst used is NH₄OH.

12. A panel comprising a hermatically sealed containment cell housing at least one layer of solvogel as claimed in any preceding claim.

13. A panel according to claim 12 wherein the containment cell is manufactured from non-reactive polymers, composites or glass.

14. A panel according to claim 13 wherein the containment cell is formed from materials selected from the group comprising polymethylmethacrylate, polycarbonates or polyesters.

15. A panel according to claim 14 wherein the cell is partially or fully transparent to visible light.

16. A panel according to claim 12 to 15 wherein the cell is tinted.

17. A panel according to claim 12 to 16 comprising a plurality of discrete layers of impregnated metal oxide networks.

18. A panel according to claim 12 to 17 wherein one or both surfaces of the panel are curved.
